(19) United States
(12) Patent Application Publication
(10) Pub. No.: US 2019/0311427 A1
(43) Pub. Date: Oct. 10, 2019

(54) Score Change Analyzer

(71) Applicant: FAIR ISAAC CORPORATION, Roseville, MN (US)

(72) Inventors: Tom Quinn, San Francisco, CA (US); Paul Panichelli, Holly Springs, GA (US); Steven Y. Hu, San Jose, CA (US); Owen Leibman, San Francisco, CA (US); Ethan J. Dornhelm, San Rafael, CA (US); Geoff Smith, Nashville, TN (US)

(21) Appl. No.: 15/945,710

(22) Filed: Apr. 4, 2018

(51) Int. Cl. G06Q 40/02; G06F 17/30

(52) U.S. Cl. CPC G06Q 40/025; G06F 17/30312

(57) ABSTRACT

A system and method to analyze the difference between a consumer's baseline credit score at one point in time and the consumer's credit score at a later point in time, and process the score difference to determine the factors in the consumer's credit profile that most explain the score difference. Systems and methods provide a mechanism for generating and formatting a record, which can be displayed on a display device, to represent those main factors of score difference.

### TECHNICAL FIELD

The subject matter described herein relates to credit scoring systems and methods, and more particularly to a score change analyzer and reporting system and method.

### BACKGROUND

Credit scoring is widely used by banks and other financial institutions for assessing, and reporting, a measure of the creditworthiness of individuals. Often, credit scores are generated for an individual for a particular transaction, such as obtaining a mortgage or other loan, or opening up a new credit line such as applying for a credit card. To generate a credit score, a credit reporting agency (also commonly referred to as a credit bureau), such as Experian, and typically at the request of a bank or financial institution, applies a modeling algorithm to the credit data associated with an individual.

Often, the individual is pre-sorted into one of a number of segments or scorecards within the overall modeling algorithm (“credit scoring system”). Each scorecard in the system has its own a unique set of characteristics or attributes to be calculated from an individual's credit report data. Based on what is typically a highly proprietary algorithm and weighting scheme, a credit scoring system will generate a score within a range of scores. Where the individual's score lands within the range of scores is a primary indication of that individual's creditworthiness. For instance, a score at a higher level of the range indicates that the individual may be a very low credit risk and is likely to be extended credit by the bank or financial institution. Conversely, a score at a lower level of the range indicates that the individual may be a very high credit risk, and is likely to be denied credit by the bank or financial institution. Credit scores have application in other areas as well, such as being a factor to determine the interest rate to charge for the loan or in determining a credit line adjustment.

Most of the effective and reliable credit scoring systems, such as the FICO® Scores produced by Fair Isaac Corporation of San Jose, Calif., focus their scoring on a comprehensive set of categories of information from the credit report, depending on the objective of the scoring system. For example, the FICO® Score is driven by a number of categories including, without limitation or particular weighting, payment history, amount of debt, length of credit history, type of new credit requested, and credit mix. A scoring algorithm may calculate characteristics from each of these categories, assign component score weights based on the characteristic values, and then produce an aggregate score.

When outputting a credit score, the credit bureau will usually also output up to five score factors indicating the top reasons why that score was not higher. For example, a credit report can include a score, as well as a list of factors that have weighed adversely on that score, such as the number of late payments, the ratio of balance to available credit, and/or a duration over which certain credit accounts have been held by the individual. Such factors may be helpful to the individual for understanding what might be affecting the individual's credit score.

However, credit scores can change over time, such as daily or even within hours, given the dynamic nature of credit accounts and transactions being reported to the credit reporting agency, and a fluid state of each individual. Accordingly, the factors that affect a particular credit score may not provide any useful insight into how or why a credit score changes, upward or downward, over time. The reasons a credit score changes may be completely different from factors most affecting a particular score at a particular point in time. Further, the sheer large number of individuals that need to be tracked over time, which can be up to several million or more, makes it very challenging for any credit reporting agency or financial institution to analyze, determine, and report meaningful score change information. Yet, providing too much information by a credit reporting agency could expose the proprietary content of the scoring models and algorithms to the public, thereby risking a potential “gaming” or reverse engineering of the scoring system by individuals or organizations.

Accordingly, what is needed is a solution that provides meaningful score change information on as many consumer records exhibiting a score change as possible, and which can generate an output in a way that facilitates a standardized set of data elements that can be used to construct an explanation that can be provided to the financial institution and eventually the consumer. Further, there is a need to provide score change information while protecting the underlying integrity of the scoring models and algorithms.

### SUMMARY

This document presents systems, methods, and techniques to analyze a difference between a consumer's baseline credit score at one point in time and their credit score at a later point in time, and attribute the score difference to the factors in their credit profile that most explain the score difference.

In varied aspects, a system, and a method executed thereon, includes calculating, by a computer processor for each of a plurality of consumers, a baseline credit score at a first point in time according to a credit scoring system executing a first scorecard. The first scorecard uses data that represents attributes associated with each consumer, each attribute being associated with one of a plurality of categories processed by the credit scoring system. A method can further include storing, by the computer processor, the baseline credit score in a database, the storing including storing at least some of the data that represents the attributes associated with each consumer.

A method further includes calculating, by the computer processor for each of the plurality of consumers, a new credit score at a second point in time according to the credit scoring system using data that represents the same or different attributes associated with each consumer as with the first scorecard. A method further includes a step of, if the new credit score has a difference from the baseline credit score by a threshold value, generating, by the computer processor for each associated consumer, an alert record based on the difference. The alert record includes a set of one or more score change factor codes calculated based on differences between the data used by the second scorecard and data used by the first scorecard, the set of one or more score change factor codes representing an explanation of the difference between the baseline credit score and the new credit score.

Implementations of the current subject matter can include, but are not limited to, systems and methods including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows an exemplary alert for being displayed in a user interface;

FIG. 2 is a flowchart of a method of analyzing the difference between a consumer's baseline credit score at one point in time and the consumer's credit score at a later point in time;

FIG. 3 is a flowchart of a method for analyzing a score change and generating and delivering score change factor codes; and

FIG. 4 is a system block diagram of a system to execute a method for analyzing a score change and generating and delivering score change factor codes.

When practical, similar reference numbers denote similar structures, features, or elements.

### DETAILED DESCRIPTION

This document describes a system and method to analyze the difference between a consumer's baseline credit score at one point in time and the consumer's credit score at a later point in time, and process the score difference to determine the factors in the consumer's credit profile that most explain the score difference. Further, the systems and methods described herein provide a mechanism for generating and formatting a record, which can be displayed on a display device, to represent those main factors of score difference.

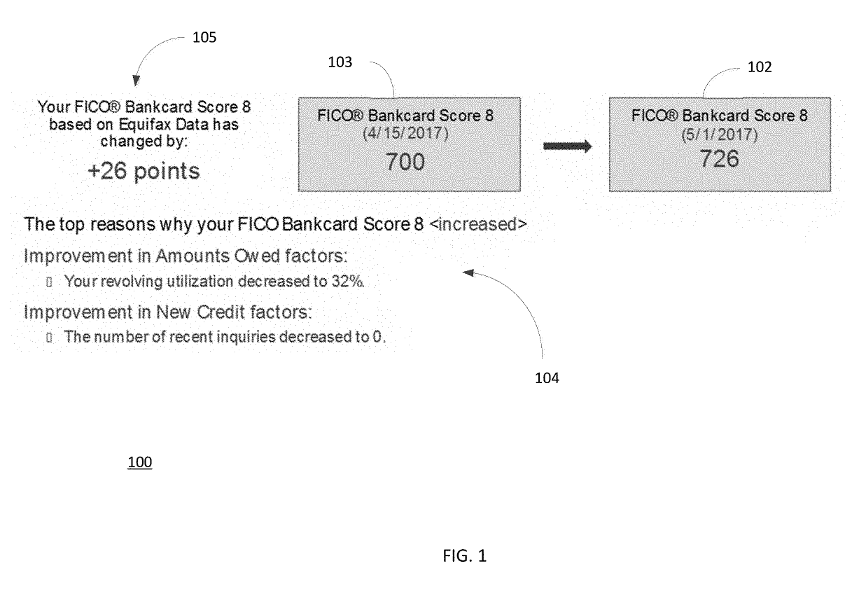

FIG. 1 shows an exemplary alert 100 for being displayed in a user interface generated by a client computing device. The client computing device can be, for example, a desktop computer, a laptop computer, a tablet computer, a mobile phone, or the like, or even a website or portal accessible using any type of computing device. The alert 100 is generated when a consumer's credit score changes by a predetermined threshold, and can be triggered either when the credit score increases by that threshold or more, or decreases by that threshold or more. Further, the predetermined threshold can be the same for an increase as a decrease, or can be different. The predetermined threshold is preferably based on a raw number increase or decrease in the credit score, but can also be based on a percentage gain or loss of the credit score.

The alert 100 provides a current score 102, and a set of score change factor codes 104 that indicate one or more reasons why the current score 102 has changed from a baseline score 103. The alert explanation 100 will also include the baseline score 103, and provide a numerical difference 105 between the current score 102 and the baseline score 103. The score change factor codes 104 can indicate reasons describing the positive increase in score, in the case where the current score 102 exceeds the baseline score 103 by the predetermined threshold, or reasons describing the negative decrease in score, in the case where the current score 102 is less than the baseline score 103 by the predetermined threshold. The score change factor codes 104 can be grouped by category (i.e., “amounts owed factors” or “new credit factors” shown in the example in FIG. 1), and can provide supporting characteristic values (i.e., percentage change, numerical changes, other data contributing to change from the baseline score 103 to the current score 102).

In some implementations, the score change factor codes 104 displayed represent only a portion of the number of reasons, from a potentially large number of reasons, that contributed to the score change. For instance, only the top two or three reasons may be displayed in the score change factor codes 104. Further, the score change factor codes 104 can provide information as to one or more reasons for the score change, without providing sensitive detail from the underlying algorithm/model by which the current score 102 and/or baseline score 103 were generated. Or, the score change factor codes 104 can be associated with categories/factors that contributed to a minimum amount of the score change, either by numerical value or percentage.

In some cases, the current score 102 is generated under the same “scorecard,” i.e., a model using the same inputs, variables, weighting scheme, and/or algorithm, etc. as the baseline score 103, within the overall credit scoring system. In other cases, the current score 102 differs from the baseline score 103 in whole or in part for the reasons that the consumer's credit activity has now warranted a new scorecard, within the overall credit scoring system, from the time the baseline score 103 was generated (or where the consumer did not previously qualify for a baseline score evaluation). The score change factor codes 104 can describe the main reasons for the score change, whether under the same scorecard or for the case of qualification or warranting of a different scorecard being applied for the current score 102 as compared with the baseline score 103.

The current score 102 and baseline score 103 are generated at two different times. The different times can be in increments of minutes, hours, days, months, or years. When a record is scored in the same scorecard at both time points, scorecard component characteristics and component scores are used to derive score change factors. Upon triggering of the alert 100, the baseline score 103 can be reset to the current score 102.

The score change factor codes 104 are carefully crafted so as to provide useful information as to why the credit score changed, without providing details that can allow the consumer or any other party to reverse-engineer or in any other way subvert the credit scoring system or algorithm. In some cases, the predetermined threshold of score change, or delta, is more easily and efficiently explained when the threshold is larger, as compared to a smaller threshold. Moreover, a larger threshold better protects the scoring model or algorithm from being reverse-engineered.

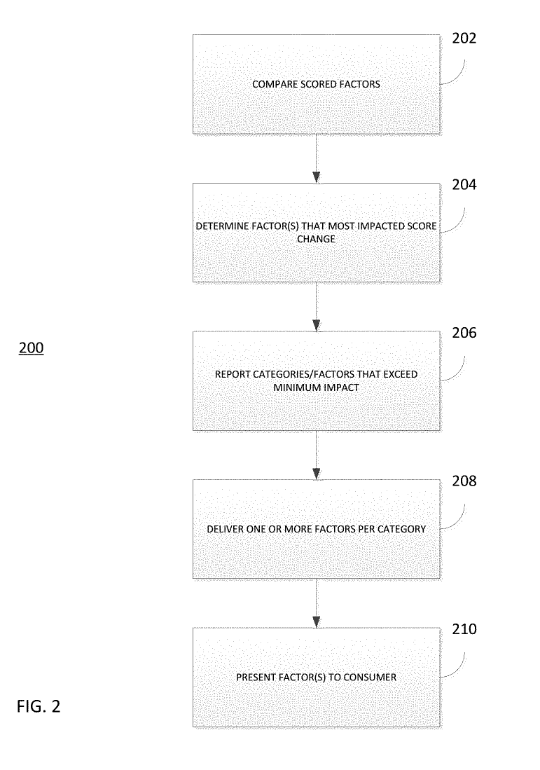

FIG. 2 is a flowchart of a method 200 for analyzing a change, beyond a predetermined threshold, between a consumer's baseline credit score at one point in time and the consumer's credit score at a later point in time, and how to determine the factors in the consumer's credit profile that most explain the score change. At 202, the scored factors of each of the baseline score and a new score are compared. At 204, the factor(s) that most impacted the score change, selected from all of the scored factors that contributed to the change, are determined. At 206, categories and/or factors that exceed a minimum impact to the score change are reported, via an alert record that is generated by a computer for transmission, delivery and display by a display device, such as a lender's computing system, at 208. Other categories and/or factors that do not exceed a minimum impact, but which may have an impact on the score change, are not reported in the alert record, but may be stored in a database for future reference. Accordingly, at 210, such factor(s) can be eventually presented to the consumer.

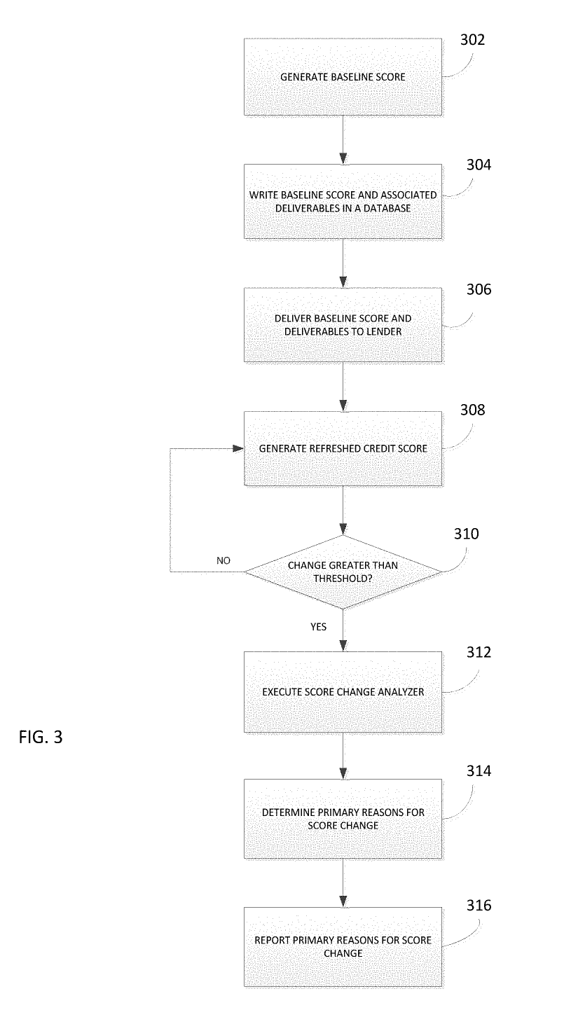

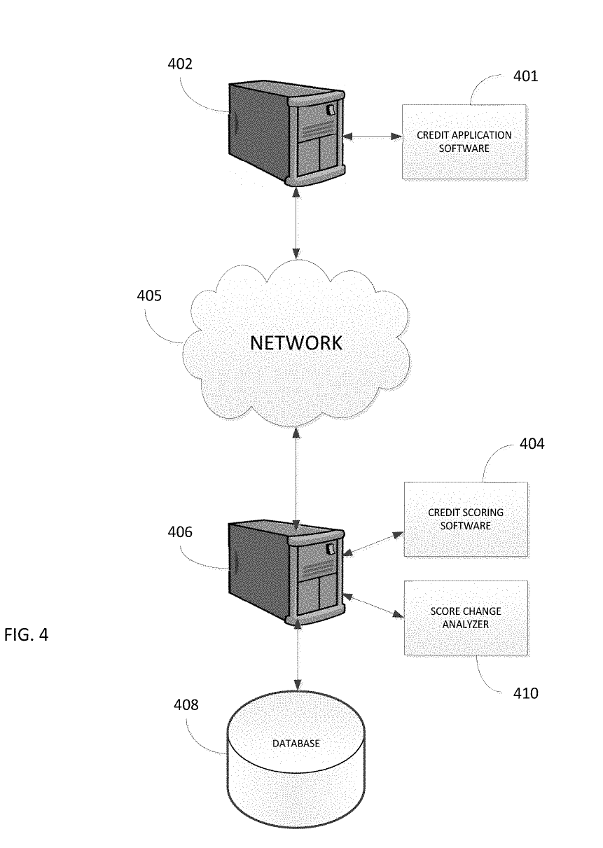

FIG. 3 is a flowchart of a method 300 for analyzing a score change and generating and delivering score change factor codes, and FIG. 4 is a system block diagram of a system 400 to execute the method 300. The system 400 includes a financial institution computing system 402, which hosts credit application software 401 for processing applications for credit or a loan. The financial institution can be a bank or other type of lender using a computing system to process applicants for credit, a loan, or other financial mechanism, and the financial institution computing system is referred to hereinafter simply as “lender 402.”

The lender 402 is connected with a credit reporting agency (CRA) 406 via a network 405, which hosts and executes scoring software 404. Credit scores generated by the CRA 406 on behalf, and at the request, of the lender 402 are stored on a database 408 housed at, or otherwise associated with, the CRA 406. The system 400 further includes a score change analyzer 410 (SCA) that includes a computing system and score change analyzer software 412 to run analytics on a baseline score (BS) that is scored at one point in time, and a refreshed score output (RSO) that is scored at another point in time, typically the next day. If the RSO differs from the BS by a threshold amount, the score change analyzer 410 will execute the score change analyzer software to determine the primary reasons why an individual consumer's score changed. In some implementations, the scoring software 404 and score change analyzer software are executed on a common computing platform, but operate on different inputs.

In some implementations, the method 300 is executed by the system 400 on a periodic basis, i.e. daily. In exemplary implementations, at 302, at a first point in time, i.e. on a first day, for records of one or more consumers in a lender's portfolio of account holders, a “baseline” is created where a credit score, score factors, score attributes, and other credit score client-deliverables are generated. The credit score, score factors, score attributes, and other credit score client-deliverables (collectively, the “Credit Score Output” (C SO)) are generated by the credit scoring software installed at the CRA 406 for records in a lender's portfolio of account holders or applicants. At 304, all outputs are written to a database of baseline records housed at the CRA 406, with attributes written out in an encrypted manner. The credit score, score factors and other client deliverables are delivered to the lender 402, at 306.

At a second point in time, i.e. on a second day, at 308, a refreshed CSO is generated on each of the records in the lender's portfolio, or on a select group of the records. The CRA then executes logic to determine if a change in the credit score between the first point in time (i.e. the “baseline”) and the second point in time (i.e. the “refreshed”) is greater than a predetermined number of points, at 310. If so, the CSO on both baseline and refreshed records is then submitted into the SCA software, at 312. Within the SCA, analytics are run on the baseline and refreshed FSO information on the matched record to determine the primary reasons why the individual's FICO score changed, at 314.

The CRA delivers the score change factor codes (for each record) to the lender along with the refreshed credit score, score factors and other credit score client-deliverables. The lender will use the output within their communications with their customer on why their credit score changed, at 316. The refreshed FSO record is written to the database in an encrypted manner as the new baseline for that consumer. The process can be repeated for subsequent points in time, i.e. days 3, 4, 5 . . . etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
calculating, by a computer processor for each of a plurality of consumers, a baseline credit score at a first point in time according to a credit scoring system executing a first scorecard, the first scorecard using data that represents attributes associated with each consumer, each attribute being associated with one of a plurality of categories processed by the credit scoring system;
storing, by the computer processor, the baseline credit score in a database, the storing including storing at least some of the data that represents the attributes associated with each consumer;
calculating, by the computer processor for each of the plurality of consumers, a new credit score at a second point in time according to the credit scoring system using data that represents the same or different attributes associated with each consumer as with the first scorecard; and
if the new credit score has a difference from the baseline credit score by a threshold value, generating, by the computer processor for each associated consumer, an alert record based on the difference, the alert record including a set of one or more score change factor codes calculated based on differences between the data used by the second scorecard and data used by the first scorecard, the set of one or more score change factor codes representing an explanation of the difference between the baseline credit score and the new credit score.

2. The method in accordance with claim 1, further comprising:
storing, by the computer processor, the new credit score of each associated consumer in the database as the new baseline credit score, if an alert was generated, the storing including storing at least some of the data that represents the same or different attributes associated with each consumer.

3. The method in accordance with claim 1, wherein the scorecard used in generating the first score is the same as the scorecard used in generating the second score.

4. The method in accordance with claim 1, wherein the scorecard used in generating the first score is different from the scorecard used in generating the second score.

4. The method in accordance with claim 1, further comprising storing, by the computer processor, the new credit score in the database as the new baseline credit score, if an alert was generated, for each associated consumer.

5. The method in accordance with claim 1, further comprising mapping the set of one or more score change factor codes of the alert record to textual descriptions of each score change factor.

7. The method in accordance with claim 1, further comprising outputting, by the computer processor, the set of alert records for the associated consumers to a database, the aggregated alert records comprising an ordered set of the one or more score change factor codes for each of the associated consumers.

8. A non-transitory computer program product storing instructions that, when executed by at least one programmable processor, cause at least one programmable processor to perform operations comprising:
calculating, for each of a plurality of consumers, a baseline credit score at a first point in time according to a credit scoring system executing a first scorecard, the first scorecard using data that represents attributes associated with each consumer, each attribute being associated with one of a plurality of categories processed by the credit scoring algorithm;
storing the baseline credit score in a database, the storing including storing at least some of the data that represents the attributes associated with each consumer;
calculating, for each of the plurality of consumers, a new credit score at a second point in time according to the same credit scoring system executing a second scorecard, the second scorecard using data that represents the same or different attributes associated with each consumer as with the first scorecard; and
if the new credit score has a difference from the baseline credit score by a threshold value, generating, for each associated consumer, an alert record based on the difference, the alert record including a set of one or more score change factor codes calculated based on differences between the data used by the second scorecard and data used by the first scorecard, the set of one or more score change factor codes representing an explanation of the difference between the baseline credit score and the new credit score.

9. The computer program product in accordance with claim 8, wherein the operations further comprise:
storing the new credit score of each associated consumer in the database as the new baseline, if an alert was generated, the storing including storing at least some of the data that represents the same or different attributes associated with each consumer.

10. The computer program product in accordance with claim 8, for deriving the score change factor codes wherein the first scorecard that was executed is the same as the second scorecard.

11. The computer program product in accordance with claim 8, for deriving the score change factor codes wherein the first scorecard that was executed is different from the second scorecard.

12. The computer program product in accordance with claim 8, wherein the operations further comprise:
mapping the set of one or more score change factor codes of the alert record to textual descriptions of each score change factor.

14. The computer program product in accordance with claim 8, wherein the operations further comprise:
outputting the alert records for the associated consumers to a database, the aggregated alert records comprising an ordered set of the one or more score change factor codes for each of the associated consumers.

15. A system comprising:
at least one programmable processor; and
a machine-readable medium storing instructions that, when executed by the at least one processor, cause the at least one programmable processor to perform operations comprising:
calculate, for each of a plurality of consumers, a baseline credit score at a first point in time according to a credit scoring system executing a first scorecard, the first scorecard using data that represents attributes associated with each consumer, each attribute being associated with one of a plurality of categories processed by the credit scoring algorithm;
store the baseline credit score in a database, the storing including storing at least some of the data that represents the attributes associated with each consumer;
calculate, for each of the plurality of consumers, a new credit score at a second point in time according to the same credit scoring system executing a second scorecard, the second scorecard using data that represents the same or different attributes associated with each consumer as with the first scorecard; and
if the new credit score has a difference from the baseline credit score by a threshold value, generate, for each associated consumer, an alert record based on the difference, the alert record including a set of one or more score change factor codes calculated based on differences between the data used by the second scorecard and data used by the first scorecard, the set of one or more score change factor codes representing an explanation of the difference between the baseline credit score and the new credit score.

16. The system in accordance with claim 15, wherein the operations further comprise:
store the new credit score of each associated consumer in the database as the new baseline, if an alert was generated, the storing including storing at least some of the data that represents the same or different attributes associated with each consumer.

17. The system in accordance with claim 15, wherein the first scorecard that was executed is the same as the second scorecard.

18. The system in accordance with claim 15, wherein the first scorecard that was executed is different from the second scorecard.

19. The system in accordance with claim 15, wherein the operations further comprise:
map the set of one or more score change factor codes of the alert record to textual descriptions of each score change factor.

20. The system in accordance with claim 15, wherein the operations further comprise:
output the alert records for the associated consumers to a database, the aggregated alert records comprising an ordered set of the one or more score change factor codes for each of the associated consumers.
